(19) United States
(12) Patent Application Publication
(10) Pub. No.: US 2009/0019955 A1
(43) Pub. Date: Jan. 22, 2009

(54) Disposable Pipette and Methods for Making and Using the Same

(75) Inventors: Guoqiang Mao, Smyrna, GA (US); Edward M. Kaucic, Newnan, GA (US); Ike Haldopoulos, Fairburn, GA (US)

Correspondence Address: JOHN S. PRATT, ESQ;KILPATRICK STOCKTON, LLP, 1100 PEACHTREE STREET, ATLANTA, GA, 30309, US

(73) Assignee: POREX CORPORATION, Fairburn, GA (US)

(21) Appl. No.: 12/108,830

(22) Filed: Apr. 24, 2008

Related U.S. Application Data
(60) Provisional application No. 60/925,922, filed on Apr. 24, 2007.

(51) Int. Cl. G01N 1/14; B01L 3/02; B32B 37/00; B23P 11/00

(52) U.S. Cl. 73/864.11; 422/100; 156/60; 29/428

(57) ABSTRACT

The present invention provides inexpensive pipettes and related structures offering high precision while minimizing the effects of operator error and chances of cross-contamination. In one embodiment, a pipette comprises a suction apparatus and a hollow body comprising a sample collection chamber, the sample collection chamber open at a first end and closed by a porous barrier material intermediate to or at a second end opposite the first end, wherein the suction apparatus is coupled to the hollow body.

### PRIOR RELATED APPLICATIONS

The present applications claims the benefit of priority to U.S. Provisional Application Ser. No. 60/925,922 filed Apr. 24, 2007 which is incorporated herein by reference in its entirety.

### FIELD OF THE INVENTION

The present invention relates to pipettes and, in particular, to disposable pipettes.

### BACKGROUND OF THE INVENTION

Pipettes are commonly used in biological and chemical applications for aspirating a quantity of fluid from a fluid source and subsequently dispensing the fluid in a desired receptacle. Frequently, the transfer of fluids with pipettes involves samples, which are moved from one set of spaced receptacles to another set of receptacles.

Several varieties of pipettes exist, including piston driven air displacement pipettes, which are highly accurate. In such devices, a vacuum is generated by the vertical travel of a metal or ceramic piston within an airtight sleeve. As the piston moves, actuated by the depression of a plunger, a vacuum is created in the volume vacated by the piston. Air from the tip of the pipette rises to fill the vacancy, and the air removed from the tip is replaced with fluid from a fluid source. The fluid within the tip can be subsequently released by depressing the plunger.

In order to facilitate the use of piston driven pipettes for many samples, disposable pipette tips are employed. Disposable tips accommodate the serial use of pipettes in the transfer of different fluids without carryover or contamination of a second sample from a pipette tip used in the collection and distribution of a first sample. The first tip, for example, is discarded and replaced by a second tip before pipetting the second sample. Disposable tips are generally constructed of a plastic material and are of a hollow, elongated, conical shape with an open proximal end for receiving and releasably mating with the distal end of a pipette device.

Although piston driven displacement pipettes are highly accurate, several problems exist with their design and operation. As provided above, the quantity of the fluid aspirated is proportional to the displacement of the piston. Piston stops are incorporated to control the amount of fluid drawn. One problem with manually piston driven pipettes is that precisely adjusting the stop position is often difficult and time consuming for the operator. In some cases, as many as twenty revolutions of the knob are required for completion of a stop adjustment.

Automatic pipettes overcome these problems by providing automatic adjustment of the piston stop. A volume input, for example, may be provided to a processor which subsequently operates a suitable motor or other drive mechanism to precisely control the stop. The drive mechanisms in automatic pipettes are usually battery powered requiring the use of rechargeable batteries or frequent battery replacement. Moreover, the expense of drive mechanisms and rechargeable batteries further increases the cost of an already expensive device.

In addition to difficult adjustment mechanisms and cost, piston driven displacement pipettes demonstrate several other disadvantages. In some cases, for example, heat from an operator's hand is absorbed through the handle of the pipette and transferred to the metallic components inside. If the pipette is operated continuously for a protracted period of time, heat accumulation becomes significant thereby causing internal components to expand and change the interplay between components. This can reduce the precision and accuracy of the pipette. The volume dispensed is dependent on the sizes of the piston and corresponding springs responsible for piston travel. As these components change in size due to thermal variances, so does the volume dispensed.

Operator fatigue is an additional disadvantage of piston driven displacement pipettes. Operator consistency is paramount to repeatable operation. The necessity of operator practice and development of good pipetting techniques is absolute. A high-quality and well-calibrated pipette in the hand of an untrained or tired operator is an unreliable instrument. Even experienced operators see a decrease in accuracy and precision as the length of an experiment or job increases. Improper drawing or dispensing angles as well as inadvertent blotting of the tip can lead to inaccuracies. Moreover, overpipetteing is an additional operator error which can lead to inaccuracies. An operator, for example, may apply a force larger than that recommended for use of the pipette resulting in excessive liquid uptake. Excessive liquid uptake results in imprecise and inaccurate sample collection volumes as well as potential contamination of the pipette.

Disposable pipettes have been introduced as potential alternatives to expensive piston driven displacement pipettes. Disposable pipettes, however, do not provide precise or accurate fluid delivery required by many applications, including biological and chemical experiments.

### SUMMARY

In view of the foregoing problems and disadvantages associated with piston driven displacement pipettes as well as presently available disposable pipettes, it would be desirable to provide inexpensive pipette devices offering high precision while reducing operator error.

The present invention provides inexpensive pipettes and related structures offering high precision while minimizing the effects of operator error and chances of cross-contamination. The present invention additionally provides methods of making pipettes as well as methods of using the same. In some embodiments, pipettes of the present invention are disposable. In some embodiments, pipettes of the present invention are fixed volume pipettes.

In one embodiment of the present invention, a pipette comprises a suction apparatus and a hollow body. The hollow body is open at two ends. The hollow body comprises a sample collection chamber, the sample collection chamber being open at a first end and closed by a porous barrier material at a second end opposite the first end, wherein the suction apparatus is coupled to the hollow body. In another embodiment, the hollow body comprises a sample collection chamber, the sample collection chamber open at a first end and closed by a porous barrier material at a point intermediate between the first end and a second end opposite the first end, wherein the suction apparatus is coupled to the hollow body. The hollow body, in some embodiments, comprises a pipette tip comprising a sample collection chamber located between the first open end of the hollow body and the porous barrier material, and a second region located between the porous barrier material and the second end of the hollow body opposite the first end of the hollow body.

In some embodiments the sample collection chamber contains a porous barrier material which is frictionally engaged with the inner wall of the sample collection chamber. In some embodiments, the second end of the sample collection chamber comprises a ledge on which the porous barrier material rests or abuts. In some embodiments, the ledge may be above, below, or both above and below the porous barrier material. In a further embodiment, the hollow body further comprises a flange positioned above or below the ledge of the second end of the sample collection chamber, wherein the flange is operable to secure the porous barrier material resting on the ledge.

In another embodiment, a pipette comprises a hollow body with a first end and a second end, the hollow body comprising a suction chamber and a sample collection chamber. In such embodiments, the sample collection chamber is open at the first end and closed by a porous barrier material. The suction chamber, in some embodiments, is located between the porous barrier material and the second end of the hollow body. The suction chamber, in some embodiments, is adjacent to the sample collection chamber and is partitioned from the sample collection chamber by the porous barrier material. In other embodiments, the suction chamber is spaced apart from the sample collection chamber.

A suction chamber, according to embodiments of the present invention, is operable to create a suction to draw a liquid into the sample collection chamber. Moreover, a suction chamber is operable to expel liquid from the sample collection chamber. In some embodiments, the suction chamber has a volume sufficient to provide a suction force operable to fill the sample collection chamber completely with a liquid sample. In some embodiments, the volume of the suction chamber is greater than or equal to the volume of the sample collection chamber. Pipettes comprising a suction chamber, in some embodiments, do not require a separate suction apparatus as the suction chamber serves as the suction apparatus. Additionally, in being part of the hollow body, a suction chamber, in some embodiments, is not a releasable or removable part of the pipette.

In another aspect, the present invention provides methods of making a pipette. In one embodiment, a method of making a pipette comprises providing a hollow body comprising a sample collection chamber, the sample collection chamber comprising an open first end and a second end, providing a porous barrier material, and disposing the porous barrier material at the second end of the sample collection chamber. In some embodiments, the porous barrier material is frictionally engaged to the inner wall of the second end of the sample collection chamber. In some embodiments, the porous barrier material is disposed on a ledge of the second end of the sample collection chamber. In some embodiments, the porous barrier material is disposed on a ledge of the second end of the sample collection chamber, wherein the ledge is located above, below or above and below the porous barrier material. A hollow body comprising a sample collection chamber, in some embodiments of methods of the present invention, further comprises a suction chamber. In some embodiments, the suction chamber of the hollow body is adjacent to the sample collection chamber and is partitioned from the sample collection chamber by the porous barrier material. In another embodiment, a method of making a pipette further comprises providing a suction apparatus and coupling the suction apparatus to the hollow body comprising the sample collection chamber.

In a further aspect, the present invention provides methods of pipetting. In one embodiment, a method of pipetting comprises providing a pipette comprising a hollow body comprising a sample collection chamber, the sample collection chamber open at a first end and closed by a porous barrier material at a second end opposite the first end and drawing a liquid into the sample collection chamber. In embodiments wherein the pipette further comprises a suction apparatus coupled to the pipette, drawing a liquid into the sample collection chamber comprises placing the first end of the sample collection chamber in the liquid and initiating suction with a suction apparatus. In embodiments wherein the hollow body of the pipette further comprises a suction chamber, drawing liquid into the sample collection chamber comprises placing the first end of the sample collection chamber in the liquid and initiating suction with the suction chamber. In one embodiment, initiating suction with a suction apparatus or suction chamber comprises squeezing the suction apparatus or suction chamber. In some embodiments of methods of pipetting, a liquid is drawn into the sample collection chamber until the liquid makes contact with the porous barrier material. In such embodiments, the liquid does not flow past the porous barrier material and the entire volume of the sample collection chamber is filled by the liquid. In a further embodiment, a method of pipetting further comprises expelling the liquid from the sample collection chamber. In some embodiments, the liquid is expelled into any desired receptacle.

In another aspect, the present invention provides methods of precision pipetting with the pipettes provided herein. The diameter of the porous barrier material is chosen relative to the diameter of the pipette tip above the sample collection chamber and inserted into the pipette tip at a location such that a desired volume for the sample collection chamber is obtained. In this manner, a desired sample volume is obtained with an acceptable degree of variance between different samples that are introduced into the sample collection chamber.

In one embodiment, a method of precision pipetting comprises providing a pipette comprising a hollow body comprising a sample collection chamber and a suction chamber, the sample collection chamber open at a first end and closed by a porous barrier material at a second end opposite the first end, obtaining a plurality of discrete liquid samples from a liquid source with the pipette wherein the volume/volume ratio of any two of the plurality of discrete liquid samples obtained ranges from about 0.8 to about 1.2. In another embodiment, the volume/volume ratio of any two of the plurality of discrete liquid samples obtained with the pipette ranges from about 0.9 to about 1.1 or from about 0.95 to about 1.05. In a further embodiment, the volume/volume ratio of any two of the plurality of discrete liquid samples obtained with the pipette ranges from about 0.99 to about 1.01. In some embodiments, obtaining a discrete liquid sample comprises placing the first end of the sample collection chamber in the liquid source, drawing the liquid into the sample collection chamber, and expelling the liquid from the sample collection chamber.

These and other embodiments are presented in greater detail in the detailed description which follows.

### BRIEF DESCRIPTION OF THE DRAWINGS

FIG. 1 illustrates a pipette according to one embodiment of the present invention.

FIG. 2 illustrates a cross-sectional view of a pipette according to one embodiment of the present invention.

FIG. 3 illustrates a cross-sectional view of a pipette according to one embodiment of the present invention.

### DETAILED DESCRIPTION

The present invention provides inexpensive pipettes and related structures offering high precision while minimizing the effects of operator error and chances of cross-contamination. The present invention additionally provides methods of making pipettes as well as methods of using the same. In some embodiments, pipettes of the present invention are disposable. In some embodiments, pipettes of the present invention are fixed volume pipettes.

In one embodiment, a pipette comprises a suction apparatus and a hollow body with a first open end and a second open end opposite the first end, the hollow body comprising a sample collection chamber, the sample collection chamber open at the first end and closed by a porous barrier material at or intermediate to the second end, wherein the suction apparatus is coupled to the hollow body.

In another embodiment, a pipette comprises a hollow body comprising a first open end and a second end opposite the first end, the hollow body further comprising a suction chamber and a sample collection chamber, the sample collection chamber open at the first end and closed by a porous barrier material intermediate to a second end opposite the first end. The suction chamber, in some embodiments, is adjacent to the sample collection chamber and is partitioned from the sample collection chamber by the porous barrier material. In other embodiments, the suction chamber is spaced apart from the sample collection chamber.

In another embodiment, a pipette comprises a hollow body comprising a suction chamber and a sample collection chamber, the sample collection chamber open at a first end and closed by a porous barrier material at a location opposite the first end and located between the first end of the sample collection chamber and the second end of the hollow body. The suction chamber, in some embodiments, is adjacent to the sample collection chamber and is partitioned from the sample collection chamber by the porous barrier material. In other embodiments, the suction chamber is spaced apart from the sample collection chamber. In some embodiments, the suction chamber is attached to the end of the hollow body opposite the first end of the sample collection chamber and is spaced apart from the sample collection chamber. In other embodiments, the suction chamber is attached to the end of the sample collection chamber opposite the first end and above the porous barrier material.

Turning now to components that can be included in pipettes of the present invention, pipettes of the present invention comprise a hollow body comprising a sample collection chamber. In some embodiments, the hollow body comprising a sample collection chamber comprises a tapered cylindrical shaft. Moreover, in some embodiments, the hollow body comprising a sample collection chamber further comprises an interior ledge. An interior ledge, according to some embodiments of pipettes of the present invention, is located at the second end of the sample collection chamber.

In some embodiments, a sample collection chamber has a volume of 10 μl or 20 μl. In other embodiments, a sample collection chamber has a volume of 50 μl or 100 μl. In another embodiment, a sample collection chamber has a volume of 150 μl, 200 μl, 250 μl, 500 μl, 750 μl or 1 ml. In a further embodiment, a sample collection chamber has a volume less than 10 μl or greater than 1 ml or 5 ml. In another embodiment, a sample collection chamber has a volume of from about 1 μl or 10 μl to about 5 ml. In some embodiments, a sample collection chamber has a volume of 1 μl or 5 μl. In one embodiment, a sample collection chamber has a volume less than 1 μl. As pipettes of the present invention are fixed or pre-selected volume pipettes, sample collection chambers, in some embodiments, are not graduated. In other embodiments, sample collection chambers, for example in the form of a pipette tip, may have a mark or circumferential line optionally associated with a number that indicates a specific volume within the pipette tip. Such markings are useful in placement of the porous barrier media within the pipette tip at specific locations to ensure precision pipetting of fluid into the sample collection chamber. Such markings are also useful in providing information to the operator as to the volume taken into the sample collection chamber.

In some embodiments, a sample collection chamber has a tolerance of less than about 20 percent of the recited volume of the sample collection chamber. The term “tolerance”, as used herein, refers to the total amount by which the actual volume of a sample collection chamber is permitted to vary from the recited volume. In one embodiment, for example, if the recited volume of the sample collection chamber is 10 μl, the actual volume of the sample collection chamber can range from 8 μl to 12 μl. In another embodiment, a sample collection chamber has a tolerance of less than about 15 percent or less than about 10 percent of the recited volume. In some embodiments, a sample collection chamber has a tolerance of less than about 5 percent or less than about 1 percent of the recited volume. In a further embodiment, a sample collection chamber has a tolerance of less than about 0.1 percent of the recited volume.

A hollow body comprising a sample collection chamber, in some, embodiments, is constructed of a polymeric material. Polymeric materials suitable for producing hollow bodies, in some embodiments, comprise thermoplastics including, but not limited to, polyolefins, polyamides, polyesters, polyurethanes, polycarbonates, polystyrenes, acrylonitrile butadiene styrene (ABS), polyvinylchloride, polyacrylates, polymethylmethacrylate, or mixtures or copolymers thereof. In some embodiments, a polyolefin comprises polyethylene, polypropylene, combinations thereof or copolymers thereof.

Polymeric materials, in some embodiments, are molded to produce a hollow body comprising a sample collection chamber. In one embodiment, a polymeric material is injection molded to produce a hollow body comprising a sample collection chamber. In another embodiment, a polymeric material is blow molded to produce a hollow body of the present invention. Blow molding, in some embodiments, comprises extrusion blow molding, injection blow molding, or stretch blow molding. Polymeric molding techniques can assist in providing sample collection chambers having the low tolerance values provided herein.

In some embodiments, a hollow body comprising a sample collection chamber is constructed of glass or a ceramic material.

In some embodiments wherein a hollow body further comprises a suction chamber, the hollow body is constructed of a thermoplastic material, an elastomeric material, or a combination thereof. In some embodiments, elastomeric materials suitable for use in hollow bodies of the present invention comprise polyisobutylene, polybutenes, butyl rubber, or combinations thereof. In another embodiment, elastomers comprise copolymers of ethylene and other polymers such as polyethylene-propylene copolymer, referred to as EPM, polyethylene-octene copolymer, and polyethylene-hexene copolymer. In a further embodiment, elastomers comprise chlorinated polyethylene or chloro-sulfonated polyethylene.

In some embodiments, elastomers suitable for use in hollow bodies of the present invention comprise 1,3-dienes and derivatives thereof. 1,3-dienes include styrene-1,3-butadiene (SBR), styrene-1,3-butadiene terpolymer with an unsaturated carboxylic acid (carboxylated SBR), acrylonitrile-1,3-butadiene (NBR or nitrile rubber), isobutylene-isoprene, cis-1,4-polyisoprene, 1,4-poly(1,3-butadiene), polychloroprene, and block copolymers of isoprene or 1,3-butadiene with styrene such as styrene-ethylene-butadiene-styrene (SEBS). In other embodiments, elastomers comprise polyalkene oxide polymers, acrylics, or polysiloxanes (silicones) or combinations thereof.

In some embodiments, the suction chamber and sample collection chamber of a hollow body comprise the same polymeric material. In other embodiments, the suction chamber and the sample collection chamber comprise different polymeric materials. In one embodiment, for example, a suction chamber comprises an elastomeric material while the sample collection chamber comprises a thermoplastic material. Moreover, hollow bodies comprising a sample collection chamber and a suction chamber can be produced by the molding techniques provided hereinabove.

A suction chamber, according to embodiments of the present invention, is operable to create a suction to draw a liquid into the sample collection chamber. Moreover, a suction chamber is operable to expel liquid from the sample collection chamber. In some embodiments, the suction chamber has a volume sufficient to provide a suction force operable to fill the sample collection chamber completely with a liquid sample. In some embodiments, the volume of the suction chamber is greater than or equal to the volume of the sample collection chamber. Pipettes comprising a suction chamber, in some embodiments, do not require a separate suction apparatus as the suction chamber serves as the suction apparatus. Additionally, in being part of the hollow body, a suction chamber is not a releasable or removable part of the pipette.

In one embodiment the suction chamber is not coupled to the sample collection chamber but is continuous with the sample collection chamber. In this embodiment relatively flexible materials may be used to make a hollow pipette, for example conical shaped, with two open ends. The porous plastic barrier is placed in one open end to create two chambers, the sample collection chamber with one open end in the lower part of hollow body and the suction chamber on the other side of the porous plastic barrier. Then the second open end in the suction chamber region is sealed with heat, ultrasonic energy or another means known to one of ordinary skill in the art to form a suction chamber in the upper part of the disposable pipette.

In addition to a hollow body comprising a sample collection chamber, pipettes, according to embodiments of the present invention, comprise a porous barrier material. A porous barrier material, in some embodiments, permits the passage of gases but inhibits and/or prevents the flow of liquids through the barrier material. In some embodiments, a porous barrier material is hydrophobic. In one embodiment, a porous hydrophobic barrier material comprises a sintered porous matrix, the sintered porous matrix comprising at least one plastic. In another embodiment, a sintered porous matrix of a hydrophobic barrier material comprises a plurality of plastics.

Plastics, as used herein, include flexible plastics and rigid plastics. Flexible plastics, in some embodiments, comprise polymers possessing moduli ranging from about 15,000 N/cm² to about 350,000 N/cm² and/or tensile strengths ranging from about 1500 N/cm² to about 7000 N/cm². Rigid plastics, according to some embodiments, comprise polymers possessing moduli ranging from about 70,000 N/cm² to about 350,000 N/cm² and have tensile strengths ranging from about 3000 N/cm² to about 8500 N/cm².

Plastics suitable for use in sintered porous matrices of hydrophobic barrier materials, in some embodiments, comprise polyolefins, polyamides, polyesters, polyurethanes, polyacrylonitriles, polycarbonates, polyvinylchloride, polyacrylates, polymethylmethacrylate, polyvinylidene fluoride, polytetrafluoroethylene, polyethersulfones, polystyrenes, polyether imides, polyetheretherketones, polysulfones, or combinations or copolymers thereof.

In some embodiments, a polyolefin comprises polyethylene, polypropylene, combinations thereof or copolymers thereof. Polyethylene, in one embodiment, comprises high density polyethylene (HDPE). High density polyethylene, as used herein, refers to polyethylene having a density ranging from about 0.92 g/cm³ to about 0.97 g/cm³. In some embodiments, high density polyethylene has a degree of crystallinity (% from density) ranging from about 50 to about 90. In another embodiment, polyethylene comprises ultrahigh molecular weight polyethylene (UHMWPE). Ultrahigh molecular weight polyethylene, as used herein, refers to polyethylene having a molecular weight greater than 1,000,000.

In some embodiments, a sintered porous matrix of a hydrophobic barrier material comprising at least one plastic has an average pore size ranging from about 1 μm to about 200 μm. In other embodiments, a sintered porous polymeric matrix has an average pore size ranging from about 40 μm to about 150 μm, from about 60 μm to about 100 μm, or from about 70 μm to about 90 μm. In another embodiment, a sintered porous polymeric matrix of a hydrophobic barrier material has an average pore size less than about 1 μm. In one embodiment, a sintered porous polymeric matrix has an average pore size ranging from about 0.1 μm to about 1 μm.

In some embodiments, porous hydrophobic barrier materials have a water intrusion pressure greater than about 0.5 psi. In some embodiments, porous hydrophobic barrier materials have a water intrusion pressure greater than 2 psi.

A porous hydrophobic barrier material, in some embodiments, further comprises a color change indicator. A color change indicator, according to embodiments of the present invention, is operable to at least partially change the color of the sintered porous polymeric matrix when contacted with an aqueous and/or organic liquid. In some embodiments, a color change indicator changes the sintered porous polymeric matrix from a first color to a second color when contacted with an aqueous and/or organic liquid. In other embodiments, a color change indicator changes the sintered porous matrix from colorless or white to colored. The color change of the sintered porous polymeric matrix, according to embodiments of the present invention depends on the color change indicator selected.

In some embodiments, the color change indicator is dispersed throughout the sintered porous polymeric matrix of the hydrophobic barrier material. In other embodiments, the color change indicator is disposed on a surface of the sintered porous polymeric matrix, wherein the surface is spaced apart from the sample collection chamber. In one embodiment, for example, the color change indicator is disposed on a surface of the sintered porous polymeric matrix facing away from the sample collection chamber. In such an embodiment, the color change indicator is in a position to determine if a liquid sample has breached the porous hydrophobic barrier material. A breach of the hydrophobic barrier material can reveal device failure indicating to a user that the device requires discarding.

Moreover, a color change indicator dispersed throughout the sintered porous polymeric matrix of a hydrophobic barrier material can indicate whether the barrier material has absorbed some of the liquid sample. Too much absorption of the liquid sample by the hydrophobic barrier material can lead to inaccuracies and inconsistencies in the volume of sample collected and subsequently expelled from the pipette. A color change in the sintered porous polymeric matrix of the hydrophobic barrier material can alert an operator to this problem.

In some embodiments, a color change indicator comprises an organic or inorganic dye, including food grade dyes. Color change indicators comprising food grade dyes, according to embodiments of the present invention, are operable to be used with biological samples due to the non-toxic nature of the food dyes.

In some embodiments, a color change indicator comprises FD&C Blue No. 1, FD&C Blue No. 2, FD&C Green No. 3, FD&C Red No. 40, FD&C Red No. 3, FD&C Yellow No. 5, FD&C Yellow No. 6, Solvent Red 24, Solvent Red 26, Solvent Red 164, Solvent Yellow 124, Solvent Blue 35, or combinations thereof. In other embodiments, a color change indicator comprises a metal salt, such as a transition metal salt. Moreover, in some embodiments, color change indicators do not comprise metal salts, such as transition metal salts.

In another embodiment, a porous hydrophobic barrier material further comprises a membrane cast onto the sintered porous polymeric matrix. In some embodiments, a membrane provides a secondary pore structure in addition to that of the sintered porous polymeric matrix. In one embodiment, a membrane has an average pore size ranging from about 0.2 nm to about 25 μm. In another embodiment, a membrane has an average pore size ranging from about 0.01 μm to about 15 μm. In a further embodiment, a membrane has an average pore size ranging from about 0.1 μm to about 10 μm or from about 1 μm to about 5 μm. Moreover, in some embodiments, a membrane has a thickness less than about 250 μm.

A membrane, according to some embodiments of the present invention, comprises a polymeric material. Polymeric materials suitable for use as a membrane, in some embodiments, comprise polyolefins such as polyethylene and/or polypropylene, as well as fluoropolymers including, but not limited to, polyvinylidene fluoride (PVDF), polytetrafluoroethylene (PTFE) and expanded-PTFE (e-PTFE). In other embodiments, polymeric membrane materials comprise polyacrylonitrile, polyether imide, polyamides, polysulfones, polyethersulfones, polyetheretherketone, polyvinlychloride, or copolymers or mixtures thereof. In other embodiments, a membrane comprises a glass fiber membrane.

In some embodiments, a membrane is attached to the sintered porous polymeric matrix of the hydrophobic barrier material through frictional forces. In one embodiment, for example, the membrane at least partially resides in the pores of the sintered porous polymeric matrix. In other embodiments, the membrane is fused to the sintered porous matrix as set for in U.S. patent application Ser. No. 10/982,392, which is hereby incorporated by reference in its entirety. In one embodiment, PVDF was applied as a solution to the sintered porous plastic barrier using methods as described in U.S. patent application Ser. No. 10/982,392 published as US 2005/0170159. Another method which may be employed is disclosed in U.S. patent application Ser. No. 11/801,152 published as US 2008/0017569, which, in one embodiment, permits use of a pure PVDF membrane with pure sintered polyethylene substrate.

In another embodiment, a sintered porous polymeric matrix of a hydrophobic barrier material further comprises at least one elastomer in addition to the at least one plastic. In some embodiments, a sintered porous matrix of a hydrophobic barrier material comprises a plurality of elastomers. Elastomers suitable for use in sintered porous matrices of hydrophobic barrier materials, according to some embodiments, comprise thermoplastic elastomers (TPE). Thermoplastic elastomers comprise polyurethanes and thermoplastic polyurethanes (TPU). Thermoplastic polyurethanes, in some embodiments, include multiblock copolymers comprising a polyurethane and a polyester or polyether.

In other embodiments, elastomers suitable for use in sintered porous matrices of hydrophobic barrier materials comprise polyisobutylene, polybutenes, butyl rubber, or combinations thereof. In another embodiment, elastomers comprise copolymers of ethylene and other polymers such as polyethylene-propylene copolymer, referred to as EPM, polyethylene-octene copolymer, and polyethylene-hexene copolymer. In a further embodiment, elastomers comprise chlorinated polyethylene or chloro-sulfonated polyethylene.

In some embodiments, elastomers suitable for use in sintered porous matrices of hydrophobic barrier materials of the present invention comprise 1,3-dienes and derivatives thereof. 1,3-dienes include styrene-1,3-butadiene (SBR), styrene-1,3-butadiene terpolymer with an unsaturated carboxylic acid (carboxylated SBR), acrylonitrile-1,3-butadiene (NBR or nitrile rubber), isobutylene-isoprene, cis-1,4-polyisoprene, 1,4-poly(1,3-butadiene), polychloroprene, and block copolymers of isoprene or 1,3-butadiene with styrene such as styrene-ethylene-butadiene-styrene (SEBS). In other embodiments, elastomers comprise polyalkene oxide polymers, acrylics, or polysiloxanes (silicones) or combinations thereof.

In a further embodiment, suitable elastomers comprise FORPRENE, LAPRENE, SKYPEL, SKYTHANE, SYNPRENE, RIMFLEX, ELEXAR, FLEXALLOY, TEKRON, DEXFLEX, TYPLAX, UCEFLEX, DEXFLEX, ENGAGE, HERCUPRENE, HI-FAX, NOVALENE, KRATON, MUTI-FLEX, EVOPRENE, HYTREL, NORDEL, VITON, VECTOR, SILASTIC, SANTOPRENE, ELASMAX, AFFINITY, ATTANE, or SARLINK.

A sintered porous polymeric matrix of a hydrphobic barrier material, according to some embodiments of the present invention, comprises at least one elastomer in an amount ranging from about 10 weight percent to about 90 weight percent. In other embodiments, a sintered porous matrix of a hydrophobic barrier material comprises at least one elastomer in an amount ranging from about 20 weight percent to about 80 weight percent. In another embodiment, a sintered porous matrix comprises at least one elastomer in an amount ranging from about 30 weight percent to about 70 weight percent. In a further embodiment, a sintered porous matrix comprises at least one elastomer in an amount ranging from about 40 weight percent to about 60 weight percent.

Incorporating one or more elastomers into the sintered porous polymeric matrix provides the hydrophobic barrier material higher degrees of flexibility. The flexible properties allow the hydrophobic barrier material, in some embodiments, to conform to the interior walls of the hollow body of a pipette of the present invention. The flexible properties, in some embodiments, additionally allow the hydrophobic barrier material to accommodate any inconsistencies or defects in the hollow body thereby providing enhanced sealing with the interior walls of the hollow body.

In another embodiment, a porous hydrophobic barrier material comprises a fibrous material. In some embodiments, a fibrous material comprises a combination of staple fibers and binder fibers. In one embodiment, a fibrous material comprises microfibers. A fibrous material, in some embodiments has an average pore size ranging from about 0.1 μm to about 50 μm or from about 1 μm to about 25 μm.

In some embodiments, a fibrous material further comprises a membrane. In one embodiment, a membrane is cast onto the fibrous material. In some embodiments, the membrane provides a secondary pore structure in addition to that of the fibrous material. In one embodiment, a membrane has an average pore size ranging from about 0.2 nm to about 25 μm. In another embodiment, a membrane has an average pore size ranging from about 0.01 μm to about 15 μm. In a further embodiment, a membrane has an average pore size ranging from about 0.1 μm to about 10 μm or from about 1 μm to about 5 μm. Moreover, in some embodiments, a membrane has a thickness less than about 250 μm.

A membrane cast onto a fibrous material, according to some embodiments of the present invention, comprises a polymeric material. Polymeric materials suitable for use as a membrane, in some embodiments, comprise polyolefins such as polyethylene and/or polypropylene as well as fluoropolymers including, but not limited to, polyvinylidene fluoride (PVDF), polytetrafluoroethylene (PTFE), and expanded-PTFE (e-PTFE). In other embodiments, polymeric membrane materials comprise polyacrylonitrile, polyether imide, polyamides, polysulfones, polyethersulfones, polyetheretherketone, polyvinlychloride, or copolymers or mixtures thereof. In other embodiments, a membrane comprises a glass fiber membrane.

In some embodiments, a membrane is attached to the fibrous material through frictional forces. In one embodiment, for example, the membrane is at least partially disposed in the pores of the fibrous material. In one embodiment, the PVDF is applied as a solution to the fibrous material using methods as described in U.S. patent application Ser. No. 10/982,392 published as US 2005/0170159. Another method which may be employed is disclosed in U.S. patent application Ser. No. 11/801,152 published as US 2008/0017569, which, in one embodiment, permits use of a pure PVDF membrane with fibrous material.

In a further embodiment, a hydrophobic barrier material comprises a laminated membrane. In one embodiment, a laminated membrane is disposed on a sintered porous polymeric substrate. In another embodiment, a laminated membrane is disposed on a woven or non-woven fibrous substrate.

In some embodiments, the porous barrier material is positioned at the second end of the sample collection chamber. Disposition of the porous barrier material at the second end of the sample collection chamber closes the sample collection chamber thereby controlling the volume of liquid that can be drawn into the sample collection chamber. The porous barrier materials also prevent and/or inhibit the flow of liquid to the remaining interior volume of the hollow body.

As provided herein, in some embodiments, the second end of the sample collection chamber comprises the porous barrier material which is frictionally engaged with the interior wall of the sample collection chamber. In another embodiment, the sample collection chamber comprises the porous barrier material which is frictionally engaged with the interior wall of the sample collection chamber at a location intermediate between the first end and the second end of the sample collection chamber. As provided herein, in some embodiments, the second end of the sample collection chamber comprises a ledge on which the porous barrier material rests or against which the porous barrier material abuts. A ledge at the second end of the sample collection chamber, according to embodiments of the present invention, facilitates the precise and accurate placement of the porous barrier material within the hollow body of the pipette. A ledge may be present below, above or both below and above the porous barrier material. As the porous barrier material limits the volume of the sample collection chamber, precise and accurate placement of the barrier material yields precise and accurate volumes of liquid samples drawn by a pipette of the present invention.

In some embodiments, the porous barrier material is held in place by a frictional fit with interior walls of the hollow body. In some embodiments, the porous barrier material resting on or abutting against the ledge is held in place by a frictional fit with interior walls of the hollow body. In other embodiments, the hollow body further comprises a flange disposed above the porous barrier material. In other embodiments, the hollow body further comprises a flange disposed above the ledge. The flange, according to embodiments of the present invention, assists in holding the porous barrier material in the proper position against the ledge. In one embodiment, for example, the flange is flexible in a single direction. Flexibility in a single direction permits the flange to bend as the porous barrier material is moved downwardly past the flange and positioned on or against the ledge. Once the porous barrier material has passed, the flange resumes an unstressed position. By having flexibility in a single direction, the flange is not operable to bend in a direction that would permit the upward movement of the porous barrier material. As a result, the flange assists in maintaining the porous barrier material on or against the ledge, especially in situations where the porous barrier material is experiencing forces attempting to drive the barrier material off the ledge and away from the second end of the sample collection chamber.

A flange, in some embodiments, protrudes from and is continuous with an interior wall of the hollow body. In one embodiment, a flange is continuous with the circumference of an interior wall of a cylindrical hollow body. In some embodiments, a flange is not continuous and is independent from an interior wall of the hollow body. In such embodiments, the flange is a separate piece which may be inserted into the hollow body prior to or subsequent to the placement of the porous barrier material. In one embodiment, a flange comprises a ring operable to be inserted into the hollow body.

In some embodiments, a porous barrier material comprises a membrane continuous with or otherwise attached to the interior of the hollow body. In one embodiment, a membrane continuous with the interior of the hollow body is formed with the hollow body according to any of the manufacturing techniques described herein. In some embodiments wherein a pipette comprises a porous barrier material comprising a membrane continuous with the interior of the hollow body, a ledge at the second end of the sample collection chamber is not present as disposition of the membrane at the second end of the sample collection chamber occurs with the formation of the hollow body.

Pipettes, according to some embodiments of the present invention, additionally comprise a suction apparatus. Suction apparatus are operable to create a suction to draw a liquid into the sample collection chamber of the pipette. Moreover, suction apparatus are operable to expel liquid from the sample collection chamber. In some embodiments, a suction apparatus comprises a bulb. In one embodiment, a bulb suitable for serving as a suction apparatus comprises an elastic bulb. In one embodiment, a suction apparatus comprises a soft blow molded material that may be fitted over the second end of the hollow body. In other embodiments, a suction apparatus comprises a suction pump or a push and release device, such as a button. In a further embodiment, a suction apparatus comprises any apparatus known to one of skill in the art for use with pipette devices.

In some embodiments, a suction apparatus is releasably coupled to the hollow body at an end distal from the sample collection chamber. In other embodiments, a suction apparatus is hingedly coupled to the hollow body. In additional embodiments, a suction apparatus may be slipped onto, screwed on or snapped onto the end of the hollow body. In another embodiment, a suction apparatus may be frictionally engaged into or onto the end of the hollow body, either being located within the end of the hollow body or outside the end of the hollow body. In a further embodiment, a suction apparatus is continuous with the hollow body. In some embodiments, for example, the suction apparatus is similar to that of the sample collection chamber in that the suction apparatus is formed as a part of the hollow body and is not a releasable or removable part of the pipette.

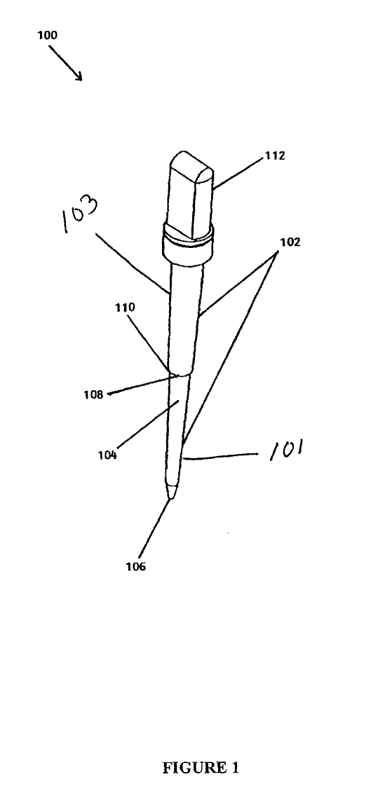

FIG. 1 illustrates a pipette according to one embodiment of the present invention. The pipette (100) displayed in FIG. 1 comprises a hollow body (102) comprising a sample collection chamber (104) housed within a pipette tip (101). The hollow body also comprises a region (103) located above the sample collection chamber (104). As shown in FIG. 1, the sample collection chamber (104) is continuous with the remainder of the hollow body (102) and is neither releasable nor separable from the hollow body (102). The sample collection chamber (104) comprises a first open end (106) at a tip operable to receive a liquid sample and a ledge (108) at a second end (110) opposite the first end. A porous barrier material (not shown) rests on or abuts against the ledge (108) at the second end (110) thereby closing the sample collection chamber (104) and inhibiting and/or preventing the passage of liquid into the remaining portions (103) of the hollow body (102). The pipette (100) additionally comprises a suction apparatus (112) coupled to the hollow body (102). The suction apparatus (112), in the embodiment illustrated in FIG. 1, comprises a bulb.

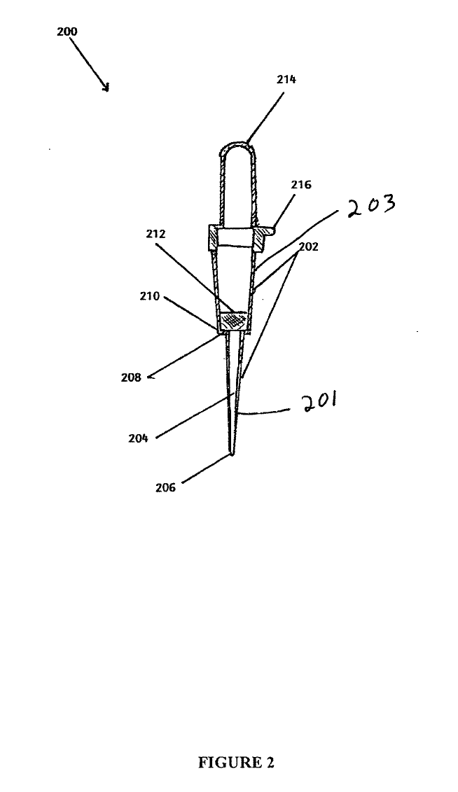

FIG. 2 illustrates a cross-sectional view of the pipette displayed in FIG. 1. As shown in FIG. 2, the pipette (200) comprises a hollow body (202) comprising a sample collection chamber (204) housed within a pipette tip (201). In one embodiment, the sample collection chamber (204) is continuous or integral with the remainder (203) of the hollow body (202) and, therefore, is not releasable or separable from the hollow body (202). In another embodiment, the sample collection chamber (204) is not continuous or integral with the remainder (203) of the hollow body (202) and, may be releasable or separable from the hollow body (202) through means such as a screw with male and female components on the ends of the parts to be joined, or a snap on means. The sample collection chamber (204) comprises a first open end (206) at a tip operable to receive a liquid sample and a ledge (208) at a second end (210) opposite the first end. A porous barrier material (212) rests on or abuts against the ledge (208) of the second end (210) thereby closing the sample collection chamber (204) and inhibiting and/or preventing the passage of liquid into the remaining portions (203) of the hollow body (202). A suction apparatus (214) is coupled to the hollow body (202). The suction apparatus (214), in the embodiment illustrated in FIG. 2, comprises a bulb. The suction apparatus (214) is additionally hingedly coupled to the hollow body (202) by hinge (216).

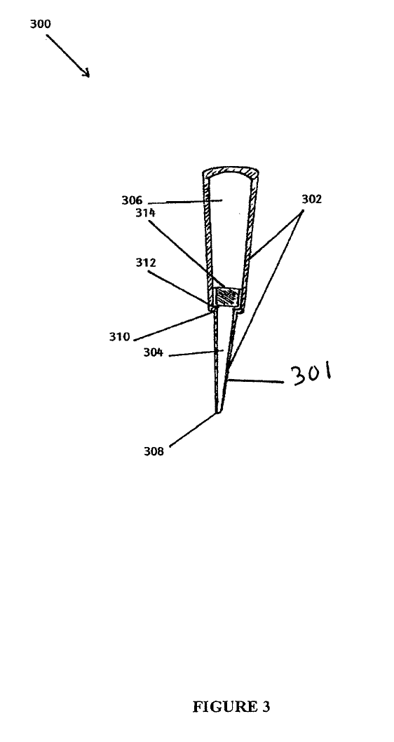

FIG. 3 illustrates a cross-sectional view of a pipette according to an embodiment of the present invention. As shown in FIG. 3, the pipette (300) comprises a hollow body (302) comprising a sample collection chamber (304) housed within a pipette tip (301) and suction chamber (306). The sample collection chamber (304) and the suction chamber (306) are continuous with one another. The sample collection chamber (304) comprises a first open end (308) at a tip operable to receive a liquid sample and a ledge (310) at a second end (312) opposite the first end. In another embodiment, there is no ledge and the porous media is simply inserted into the pipette tip and frictionally engaged thereto. The sample collection chamber (304) comprises a first open end (308) at a tip operable to receive a liquid sample and a ledge (310) at a second end (312) opposite the first end. A porous barrier material (314) rests on or abuts against the ledge (310) of the second end (312) thereby closing the sample collection chamber (304) and partitioning the volume of the sample collection chamber (304) from the volume of the suction chamber (306). A liquid sample can be drawn into the sample collection chamber (304) by creating a suction force with the suction chamber (306).

In some embodiments, pipettes of the present invention are disposable and/or not reusable.

In another aspect, the present invention provides methods of making a pipette. In one embodiment, a method of making a pipette comprises providing a hollow body comprising a sample collection chamber, the sample collection chamber comprising an open first end and a second end, providing a porous barrier material, and disposing the porous barrier material at the second end of the sample collection chamber. In some embodiments, the porous barrier material is disposed on a ledge of the second end of the sample collection chamber. As provided herein, disposing the porous barrier material on a ledge of the second end of the sample collection chamber can enable precise and accurate placement of the porous barrier material leading to precise and accurate sample volumes collected by the sample collection chamber.

In some embodiments, a hollow body comprising a sample collection chamber further comprises a suction chamber. The suction chamber, in some embodiments, is adjacent to the sample collection chamber and is partitioned from the sample collection chamber by the porous barrier material. In some embodiments, providing a hollow body comprises providing a sample collection chamber, providing a suction chamber, and coupling the sample collection chamber to the suction chamber to form the hollow body. In other embodiments, a suction apparatus is hingedly coupled to the hollow body. In additional embodiments, a suction apparatus may be slipped onto, screwed on or snapped onto the end of the hollow body. In another embodiment, a suction apparatus may be frictionally engaged into or onto the end of the hollow body, either being located within the end of the hollow body or outside the end of the hollow body. In one embodiment, coupling the sample collection chamber to the suction chamber comprises fusing the sample collection chamber to the suction chamber. In another embodiment, coupling the sample collection chamber to the suction chamber comprises adhering or gluing the sample collection chamber to the suction chamber. In a further embodiment, coupling the sample collection chamber to the suction chamber comprises screwing the sample collection and suction chambers together. The sample collection chamber, for example, may contain threads and the suction chamber a mate for the threads or vice versa. In one embodiment, a hollow body comprising a sample collection chamber and suction chamber is molded as one piece by any of the molding processes provided herein.

In another embodiment, a method of making a pipette further comprises providing a suction apparatus and coupling the suction apparatus to the hollow body.

In a further aspect, the present invention provides methods of pipetting. In one embodiment, a method of pipetting comprises providing a pipette comprising a hollow body comprising a sample collection chamber, the sample collection chamber open at a first end and closed by a porous barrier material at a second end opposite the first end and drawing a liquid into the sample collection chamber. In embodiments wherein the pipette further comprises a suction apparatus coupled to the pipette, drawing a liquid into the sample collection chamber comprises placing the first end of the sample collection chamber in the liquid and initiating suction with a suction apparatus. In embodiments wherein the hollow body of the pipette further comprises a suction chamber, drawing liquid into the sample collection chamber comprises placing the first end of the sample collection chamber in the liquid and initiating suction with the suction chamber. In one embodiment, initiating suction with a suction apparatus or suction chamber comprises squeezing the suction apparatus or suction chamber. In some embodiments of methods of pipetting, a liquid is drawn into the sample collection chamber until the liquid makes contact with the porous barrier material. In such embodiments, the liquid does not flow past the porous barrier material and the entire volume of the sample collection chamber is filled by the liquid. In a further embodiment, a method of pipetting further comprises expelling the liquid from the sample collection chamber. In some embodiments, the liquid is expelled into any desired receptacle.

In another aspect, the present invention provides methods of precision pipetting with pipettes provided herein. In one embodiment, a method of precision pipetting comprises providing a pipette comprising a hollow body comprising a sample collection chamber, the sample collection chamber open at a first end and closed by a porous barrier material at a second end opposite the first end, obtaining a plurality of discrete liquid samples from a liquid source with the pipette wherein the volume/volume ratio of any two of the plurality of discrete liquid samples obtained ranges from about 0.8 to about 1.2. In another embodiment, the volume/volume ratio of any two of the plurality of discrete liquid samples obtained with the pipette ranges from about 0.9 to about 1.1 or from about 0.95 to about 1.05. In a further embodiment, the volume/volume ratio of any two of the plurality of discrete liquid samples obtained with the pipette ranges from about 0.99 to about 1.01. In some embodiments, obtaining a discrete liquid sample comprises placing the first end of the sample collection chamber in the liquid source, drawing the liquid into the sample collection chamber, and expelling the liquid from the sample collection chamber.

### EXAMPLE 1

The disposable precision pipette was composed of an injection molded polypropylene hollow body with shape shown as 202 in FIG. 2 although no ledge was present in the hollow body in this example and no hinge was present. A sintered porous plastic barrier with average pore size of 8 microns 212 and elastic suction chamber 214 are shown in FIG. 2. The sintered porous plastic barrier 212 with average pore size of 8 microns was inserted into the hollow body 202 at the location 208 using a rod. The porous plastic barrier had good frictional contact with the inner wall of the hollow body 202 to ensure stability within the hollow body. The volume of the sampling chamber 204 was 100 ul and was determined by a precision injection molding process. The suction chamber was a rubber bulb and was made from an elastic rubber material. The suction chamber had a volume of about 500 ul. The top end of the sample collection chamber 204, above the porous media on the second end opposite the first open end was inserted into the open hole of the base of the rubber bulb that was suction chamber.

The first open end (206) of the tip was immersed into a beaker containing water. The suction chamber was squeezed with fingers and then the fingers were relaxed. The water moved up from the sample chamber and stopped at the porous barrier surface that faced the sample chamber. No water passed the barrier. The water was released to the targeted container by squeezing the suction chamber. The process was repeated several times and water volumes were within 10% of the desired volume of 100 ul.

### EXAMPLE 2

The disposable precision pipette was composed of an injection molded polypropylene pipette with shape as shown 202 in FIG. 2 although no ledge was present in the hollow body in this example and no hinge was present. A sintered porous plastic barrier was composed of sintered porous polyethylene substrate with the average pore size of 80 microns (Porex) and a PVDF membrane with average pore size of 0.5 microns cast in the sintered polyethylene substrate 212 and elastic suction chamber 214. The PVDF was applied as a solution to the sintered porous plastic barrier using methods as described in U.S. patent application Ser. No. 10/982,392 published as US 2005/0170159.

The sintered porous plastic barrier 212 composed of sintered polyethylene substrate and PVDF membrane was inserted into the pipette tip 202 at the location 208 such that the PVDF membrane faced the sample collection chamber. The insertion was performed using a rod. The porous plastic barrier had good contact with the wall of the hollow body 202 to ensure stability. The volume of the sampling chamber 204 was 100 ul and was determined by a precision injection molding process. A suction chamber was attached to the top of the sample collection chamber 204. The suction chamber was an elastic rubber material and had a volume of about 500 ul. The pipette tip was inserted into the open hole of the suction chamber.

The tip (206) was immersed into a beaker containing water. The suction chamber was squeezed with fingers and then the fingers were relaxed. The water moved up from the sample chamber and stopped at the porous barrier surface that faced the sample chamber. No water passed the barrier. The water was released to the targeted container by squeezing the suction chamber. The process was repeated several times and water volumes were within 10% of the desired volume of 100 ul.

### EXAMPLE 3

The disposable precision pipette was composed of an injection molded polypropylene pipette with shape shown as 202 in FIG. 2 although no ledge was present in the hollow body in this example and no hinge was present. The porous barrier material was composed of sintered porous polyethylene with average pore size of 80 microns (Porex) and an e-PTFE membrane (Pall) with average pore size of 0.5 micron. The e-PTFE membrane was placed adjacent to the sintered porous polyethylene. The e-PTFE membrane was slightly larger in diameter than the diameter of the porous barrier material to which it was opposed. The porous barrier was inserted into the injection molded polypropylene housing using mechanical means and the e-PTFE membrane side faced the sample collection chamber.

The tip 206 was immersed into a beaker containing water. The suction chamber was squeezed with fingers and then the fingers were relaxed. The water moved up from the sample chamber and stopped at the porous barrier surface that faced the sample chamber. No water passed the barrier. The water was released to the targeted container by squeezing the suction chamber. The process was repeated several times and water volumes were within 10% of the desired volume of 100 ul.

All patents, patent applications and publications cited herein are incorporated herein by reference in their entirety. Various embodiments of the invention have been described in fulfillment of the various objectives of the invention. It should be recognized that these embodiments are merely illustrative of the principles of the present invention. Numerous modifications and adaptations thereof will readily apparent to those skilled in the art without departing from the spirit and scope of the invention.

We claim:

1. A pipette comprising:
a hollow body comprising a first open end and a second open end opposite the first open end, the hollow body further comprising a sample collection chamber open at the first open end and closed by a porous barrier material intermediate to or at the second open end; and,
a suction apparatus coupled to the hollow body at the second open end.

2. The pipette of claim 1, wherein the porous barrier material is frictionally engaged to or abuts a ledge on an interior wall of the sample collection chamber.

3. The pipette of claim 1, wherein the sample collection chamber has a volume ranging from about 10 μl to about 5 ml.

4. The pipette of claim 1, wherein the hollow body comprises a polymeric material comprising a polyolefin, polyamide, polyurethane, polyester, polycarbonate, polystyrene, polyacrylate, polyvinylchloride, or copolymers or mixtures thereof.

5. The pipette of claim 1, wherein the porous barrier material comprises a sintered porous polymeric matrix.

6. The pipette of claim 5, wherein the sintered porous polymeric matrix comprises a polyolefin.

7. The pipette of claim 6, wherein the polyolefin comprises polyethylene, polypropylene, a copolymer thereof or a combination thereof.

8. The pipette of claim 5, wherein the porous barrier material further comprises a polymeric membrane coupled to or adjacent to the sintered porous polymeric matrix.

9. The pipette of claim 8, wherein the polymeric membrane comprises polyvinylidene fluoride, polyethersulfone, polypropylene, polyamide, polytetrafluoroethylene, expanded polytetrafluoroethylene, or combinations thereof.

10. The pipette of claim 1, wherein the porous barrier material has a water intrusion pressure greater than 0.5 psi.

11. The pipette of claim 5, wherein the sintered porous polymeric matrix comprises at least one thermoplastic and at least one elastomer.

12. A pipette comprising:
a hollow body comprising a first open end and a second end opposite the first end, the hollow body comprising a sample collection chamber open at the first open end and closed by a porous barrier material; and,
a suction apparatus comprising a suction chamber within the hollow body defined by the porous barrier material and the second end of the hollow body, wherein the second end is closed.

13. The pipette of claim 12, wherein the porous barrier material is frictionally engaged to or abuts a ledge on an interior wall of the sample collection chamber.

14. The pipette of claim 12, wherein the sample collection chamber has a volume ranging from about 10 μl to about 5 ml.

15. The pipette of claim 12, wherein the hollow body comprises a polymeric material comprising a polyolefin, polyamide, polyurethane, polyester, polycarbonate, polystyrene, polyacrylate, polyvinylchloride, or copolymers or mixtures thereof.

16. The pipette of claim 12, wherein the porous barrier material comprises a sintered porous polymeric matrix.

17. The pipette of claim 16, wherein the sintered porous polymeric matrix comprises a polyolefin.

18. The pipette of claim 17, wherein the polyolefin comprises polyethylene, polypropylene, a copolymer thereof or a combination thereof.

19. The pipette of claim 16, wherein the porous barrier material further comprises a polymeric membrane coupled to or adjacent to the sintered porous polymeric matrix.

20. The pipette of claim 19, wherein the polymeric membrane comprises polyvinylidene fluoride, polyethersulfone, polypropylene, polyamide, polytetrafluoroethylene, expanded polytetrafluoroethylene, or combinations thereof.

21. The pipette of claim 12, wherein the porous barrier material has a water intrusion pressure greater than 0.5 psi.

22. The pipette of claim 16, wherein the sintered porous polymeric matrix comprises at least one thermoplastic and at least one elastomer.

23. A pipette comprising:
a suction apparatus comprising a suction chamber; and,
a hollow body comprising a first open end and a second open end opposite the first open end, the hollow body further comprising a sample collection chamber, the sample collection chamber open at the first open end and closed by a porous barrier material intermediate to or at the second open end, wherein the suction apparatus is coupled to the sample collection chamber at the second open end and the porous barrier material comprises a sintered polymeric matrix comprising a polyolefin.

24. The pipette of claim 31, wherein the porous barrier material is frictionally engaged to or abuts a ledge on an interior wall of the sample collection chamber.

25. The pipette of claim 23, wherein the sample collection chamber has a volume ranging from about 10 μl to about 5 ml.

26. The pipette of claim 23, wherein the hollow body comprises a polymeric material comprising a polyolefin, polyamide, polyurethane, polyester, polycarbonate, polystyrene, polyacrylate, polyvinylchloride, or copolymers or mixtures thereof.

27. The pipette of claim 23, wherein the porous barrier material comprises a sintered porous polymeric matrix.

28. The pipette of claim 27, wherein the sintered porous polymeric matrix comprises a polyolefin.

29. The pipette of claim 28, wherein the polyolefin comprises polyethylene, polypropylene, a copolymer thereof or a combination thereof.

30. The pipette of claim 27, wherein the porous barrier material further comprises a polymeric membrane coupled to or adjacent to the sintered porous polymeric matrix.

31. The pipette of claim 30, wherein the polymeric membrane comprises polyvinylidene fluoride, polyethersulfone, polypropylene, polyamide, polytetrafluoroethylene, expanded polytetrafluoroethylene, or combinations thereof.

32. The pipette of claim 23, wherein the porous barrier material has a water intrusion pressure greater than 0.5 psi.

33. The pipette of claim 27, wherein the sintered porous polymeric matrix comprises at least one thermoplastic and at least one elastomer.

34. A method of making a pipette comprising:
providing a hollow body comprising an first open end and an second open end opposite the first open end, the hollow body further comprising a sample collection chamber between the first open end and the second open end;
providing a porous barrier material;
disposing the porous barrier material intermediate to or at the second open end; and
coupling a suction device to the second open end.

35. A method of making a pipette comprising:
providing a hollow body with a first open end and a second open end opposite the first open end;
providing a porous barrier material;
disposing the porous barrier material into the hollow body to form a sample collection chamber between the first open end of the hollow body and the porous barrier material; and,
sealing the second open end of hollow body to form a suction chamber between the sealed second end of the hollow body and the porous barrier material.

36. A method of pipetting a predetermined volume of liquid comprising:
providing the pipette of claim 1;
drawing a volume of liquid equal to the volume of a sample collection chamber into the sample collection chamber with the suction apparatus; and,
expelling the liquid from the sample collection chamber.

37. A method of pipetting a predetermined volume of liquid comprising:
providing the pipette of claim 2;
drawing a volume of liquid equal to the volume of a sample collection chamber into the sample collection chamber with the suction apparatus; and,
expelling the liquid from the sample collection chamber.

38. A method of pipetting a predetermined volume of liquid comprising:
providing the pipette of claim 3;
drawing a volume of liquid equal to the volume of a sample collection chamber into the sample collection chamber with the suction apparatus; and,
expelling the liquid from the sample collection chamber.
